(19) United States
(12) Patent Application Publication
(10) Pub. No.: US 2014/0015692 A1
(43) Pub. Date: Jan. 16, 2014

(54) TRAFFIC CONE ASSEMBLY

(71) Applicant: Yueh-Che Sun, Chiayi City (TW)

(72) Inventor: Yueh-Che Sun, Chiayi City (TW)

(21) Appl. No.: 13/547,297

(22) Filed: Jul. 12, 2012

(51) Int. Cl. G08G 1/0955

(52) U.S. Cl. 340/908

(57) ABSTRACT

A traffic cone assembly has a base, a telescopic unit and an illuminating unit. The base has an inner space and a base hole formed through a top surface of the base. The telescopic unit is capable of telescoping longitudinally, is securely connected with the base and has a bottom, a middle and a top. The bottom of the telescopic unit is securely mounted in the inner space of the base. The middle of the telescopic unit protrudes out from the base hole. An LED (light emitting diode) of the illuminating unit is securely mounted on the top of the telescopic unit. Because the LED mounted on the top of the telescopic unit can illuminate, the traffic cone assembly can be seen with good visibility.

### BACKGROUND OF THE INVENTION

1. Field of the Invention

The present invention relates to a traffic cone assembly, and more particularly to a traffic cone assembly having good visibility.

2. Description of Related Art

With reference to FIG. 8, a conventional traffic cone 80 has a base 81, a cone 82 and a light-reflecting strip 83. The base 81 is a rectangular plate. The cone 82 is securely mounted on a top of the base 81. The light-reflecting strip 83 is securely mounted around a top of the cone 82.

The traffic cone 80 is a marker that is placed on roads or sidewalks to temporarily redirect traffic in a safe manner. The traffic cone 80 is often used to separate or merge lanes during road construction projects or automobile accidents.

Although the light-reflecting strip 83 can reflect light, the light-reflecting strip 83 does not illuminate. Accordingly, the visibility of the conventional traffic cone 80 is about 20 meters and is insufficient, especially in heavy rain or mist. Consequently, the conventional traffic cone 80 is not easily seen in heavy rain or mist and is easily hit by a driver.

Moreover, the conventional traffic cone 80 is big and is not telescopic. Multiple traffic cones 80 are not easy to be put in the car trunk. This is inconvenient.

To overcome the shortcomings, the present invention tends to provide a traffic cone assembly to mitigate the aforementioned problems.

### SUMMARY OF THE INVENTION

The main objective of the invention is to provide a traffic cone assembly having good visibility.

A traffic cone assembly has a base, a telescopic unit and an illuminating unit. The base has an inner space and a base hole formed through a top surface of the base. The telescopic unit is capable of telescoping longitudinally, is securely connected with the base and has a bottom, a middle and a top. The bottom of the telescopic unit is securely mounted in the inner space of the base. The middle of the telescopic unit protrudes out from the base hole. An LED (light emitting diode) of the illuminating unit is securely mounted on the top of the telescopic unit. Because the LED mounted on the top of the telescopic unit can illuminate, the traffic cone assembly can be seen. The visibility of the traffic cone assembly is good.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a traffic cone assembly in accordance with the present invention;

FIG. 2 is a perspective view in partial section of the traffic cone assembly in FIG. 1;

FIG. 3 is an enlarged cross sectional side view of the traffic cone assembly in FIG. 1;

FIG. 4 is a perspective view in partial section of the traffic cone assembly in FIG. 1 showing the telescopic unit received in the base;

FIG. 5 is a perspective view of the traffic cone assembly in FIG. 4;

FIG. 6 is a rear perspective view of the traffic cone assembly in FIG. 4;

FIG. 7 is an operational side view in partial section of the traffic cone assembly in FIG. 4 showing multiple traffic cone assemblies piled up; and

FIG. 8 is a perspective view of the conventional traffic cone in accordance with the prior art.

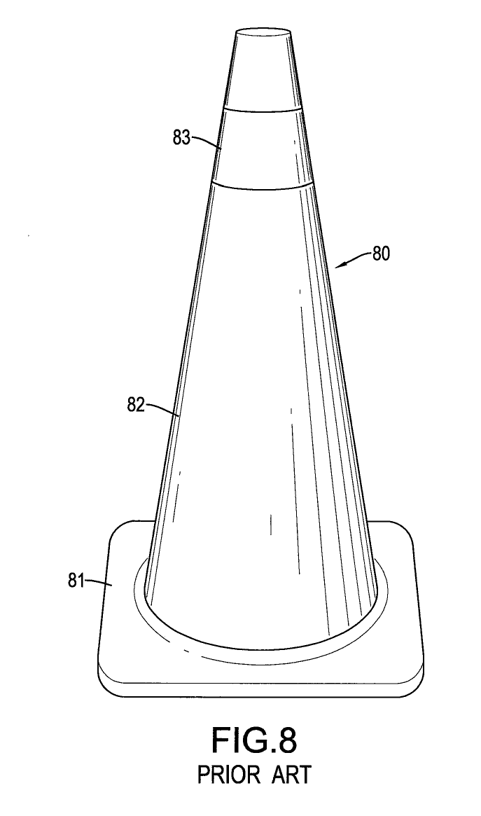

### DETAILED DESCRIPTION OF PREFERRED EMBODIMENT

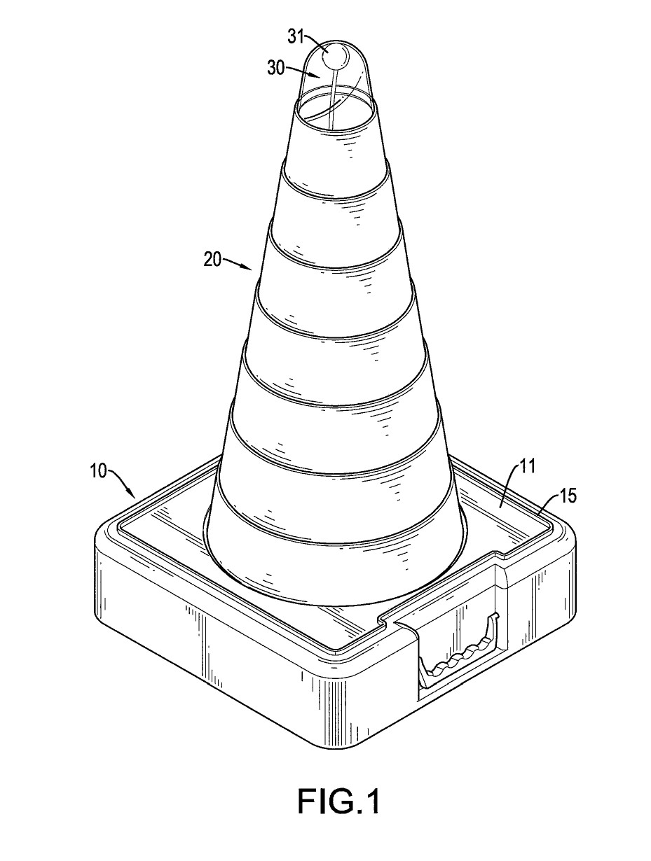

With reference to FIGS. 1 to 3, a traffic cone assembly in accordance with the present invention comprises a base 10, a telescopic unit 20 and an illuminating unit 30.

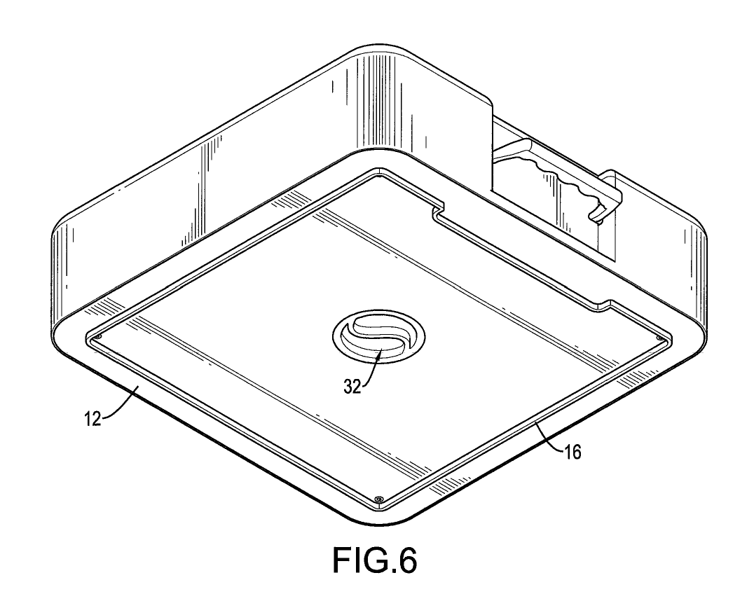

With reference to FIGS. 1 to 3 and 6, the hollow base 10 is a box and has a top surface 11, a bottom surface 12, a base hole 13 and an inner space 14. The bottom surface 12 of the base 10 is opposite to the top surface 11 of the base 10. The base hole 13 is round, is formed through the top surface 11 of the base 10 and communicates with the inner space 14 of the base 10.

Preferably, the base 10 has a top rib 15 and a bottom rib 16. The top rib 15 is loop-shaped and is mounted on the top surface 11 of the base 10. The bottom rib 16 is loop-shaped, is mounted on the bottom surface 12 of the base 10 and has a shape the same as that of the top rib 15. An outer surface of the bottom rib 16 of the traffic cone assembly is capable of abutting an inner surface of the top rib 15 of another traffic cone assembly.

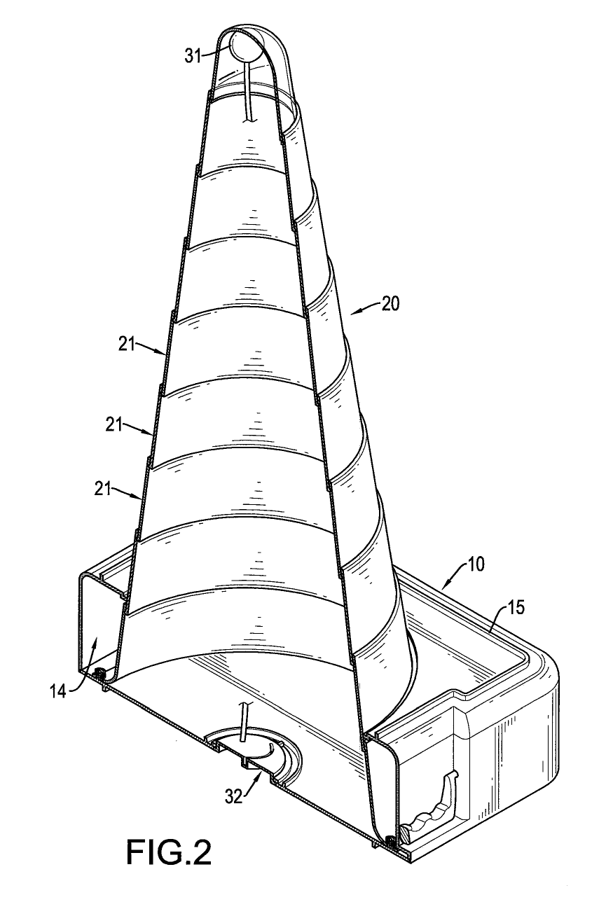

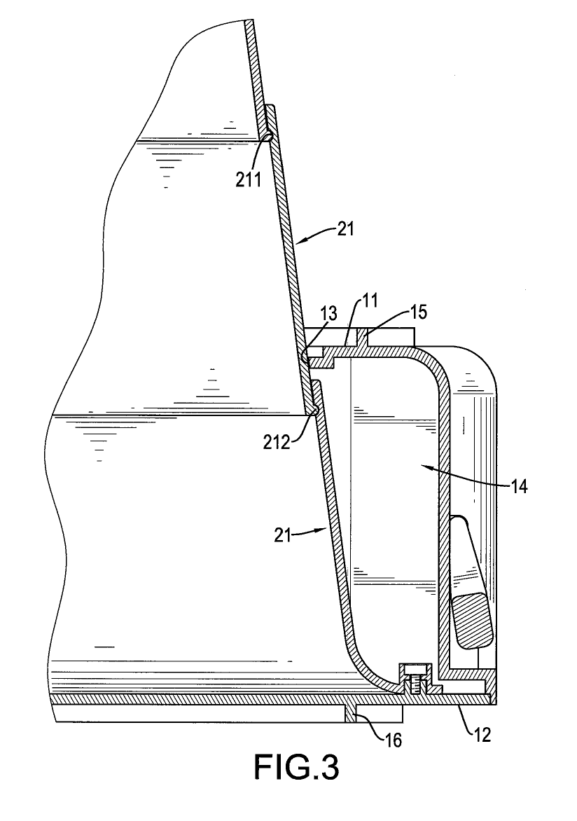

With reference to FIGS. 2 and 3, the telescopic unit 20 is capable of telescoping longitudinally, is securely connected with the base 10 and has a bottom, a middle and a top. The bottom of the telescopic unit 20 is securely mounted in the inner space 14 of the base 10 by bolts. The middle of the telescopic unit 20 protrudes out from the base hole 13. The top of the telescopic unit 20 is formed above the middle of the telescopic unit 20.

Preferably, the telescopic unit 20 is conical and has multiple cone members 21 arranged longitudinally. Each adjacent two of the cone members 21 are respectively defined as an upper cone member and a lower cone member. Each lower cone member has an inner surface and a groove 211. The groove 211 of each lower cone member is annular and is radially formed around a top of the inner surface of the lower cone member.

Each upper cone member is located above a corresponding one of the lower cone members and has an outer surface and a positioning rib 212. The positioning rib 212 of each upper cone member is annular, radially protrudes around a bottom of the outer surface of the upper cone member and engages the groove 211 of a corresponding one of the lower cone members.

With reference to FIG. 2, the illuminating unit 30 has an LED (light emitting diode) 31. The LED 31 is securely mounted in the top of the telescopic unit 20, i.e. the topmost cone member 21. Preferably, the illuminating unit 30 has a spring-driven generator 32 electrically connected with the LED 31. The spring-driven generator 32 may be conventional and detailed description is omitted. When a spring of the spring-driven generator 32 is rotated about 50 times, the LED 31 can illuminate about 1 to 2 hours. Therefore, the LED 31 can illuminate by a manual operation for emergency.

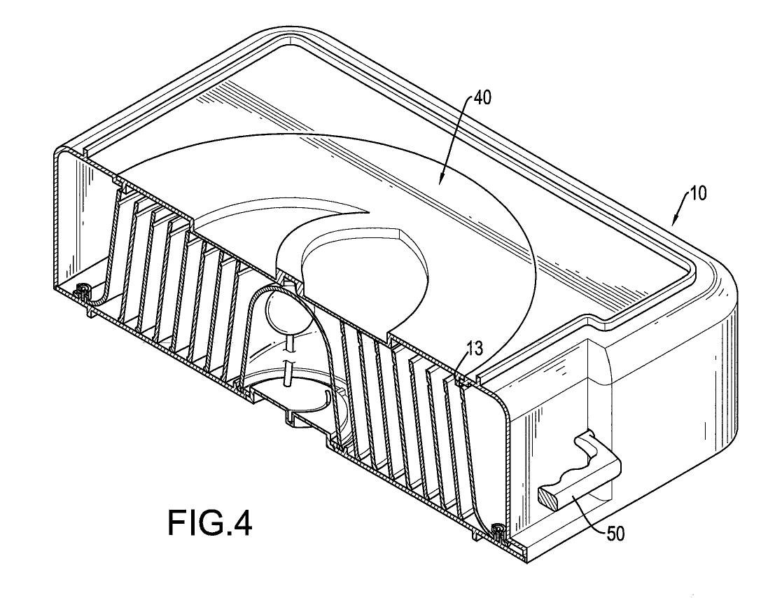

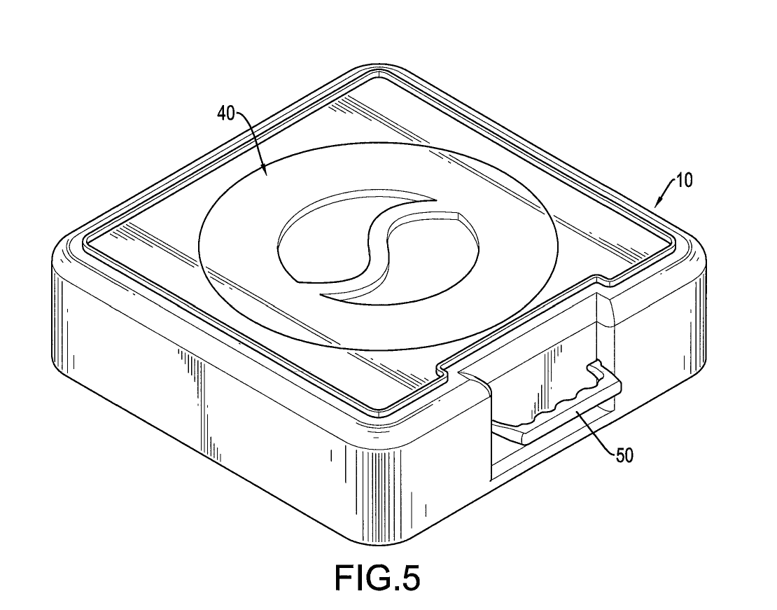

With reference to FIGS. 4 and 5, the telescopic unit 20 of the traffic cone assembly in accordance with the present invention telescopes and is received completely in the base 10. The traffic cone assembly further has a cover 40 mounted in the base hole 13 to close the inner space 14 of the base 10.

Preferably, the traffic cone assembly has a handle 50 pivotally mounted on an outer surface of the base 10. With the handle 50, the traffic cone assembly can be carried easily by users.

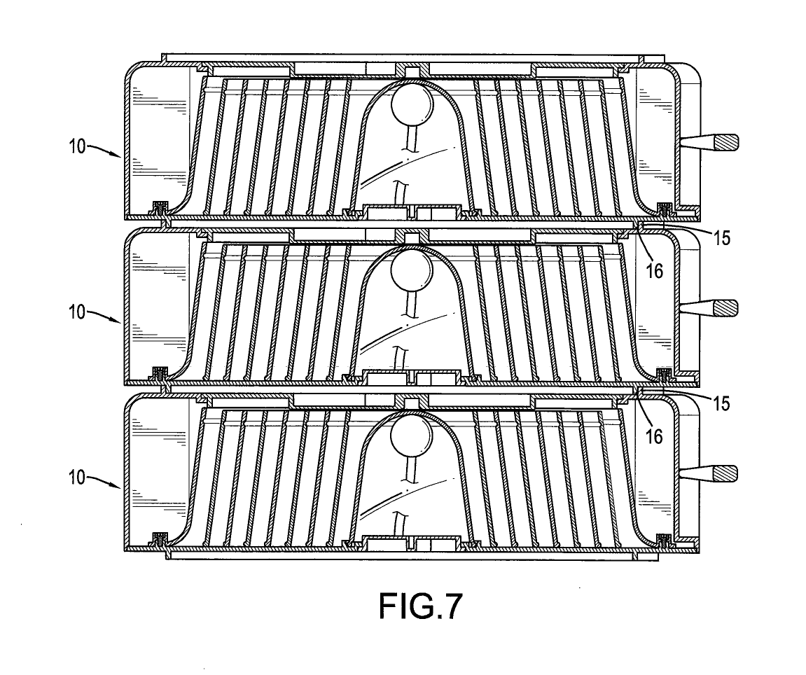

With reference to FIG. 7, multiple traffic cone assemblies in accordance with the present invention are piled up. The outer surface of the bottom rib 16 of the traffic cone assembly abuts the inner surface of the top rib 15 of another traffic cone assembly.

From the above description, it is noted that the present invention has the following advantages:

1. Good Visibility:

Because the LED 31 mounted on the top of the telescopic unit 20 can illuminate, the traffic cone assembly can be seen even in heavy rain or mist. The visibility of the traffic cone assembly is good.

2. Easily Piled:

Because the telescopic unit 20 is telescopic and can be received in the base 10, the traffic cone assembly is easily folded. With the top ribs 15 and the bottom ribs 16, multiple traffic cone assemblies in accordance with the present invention are easily piled and are easily put in the car trunk.

3. Standing Steadily:

The base 10 of the traffic cone assembly is a box, while the conventional base 81 is a plate. Accordingly, the volume of the base 10 is larger than that of the conventional base 81 and the weight of the base 10 is heavier than that of the conventional base 81. Consequently, the traffic cone assembly can stand steadily.

4. Manual Operation:

When a spring of the spring-driven generator 32 is rotated about 50 times, the LED 31 can illuminate about 1 to 2 hours. Therefore, the LED 31 can illuminate by a manual operation for emergency.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A traffic cone assembly comprising:
a hollow base having:
an inner space;
a top surface;
a base hole formed through the top surface of the base and communicating with the inner space of the base; and
a telescopic unit capable of telescoping longitudinally, securely connected with the base and having:
a bottom securely mounted in the inner space of the base;
a middle protruding out from the base hole; and
a top formed above the middle of the telescopic unit; and
an illuminating unit having:
an LED (light emitting diode) securely mounted in the top of the telescopic unit.

2. The traffic cone assembly as claimed in claim 1, wherein
the telescopic unit is conical and has multiple cone members arranged longitudinally, wherein each adjacent two of the cone members are respectively defined as an upper cone member and a lower cone member;
each lower cone member has
an inner surface; and
an annular groove radially formed around a top of the inner surface of the lower cone member; and
each upper cone member is located above a corresponding one of the lower cone members and has
an outer surface; and
an annular positioning rib radially protruding around a bottom of the outer surface of the upper cone member and engaging the groove of a corresponding one of the lower cone members.

3. The traffic cone assembly as claimed in claim 1, wherein the illuminating unit has a spring-driven generator electrically connected with the LED.

4. The traffic cone assembly as claimed in claim 2, wherein the illuminating unit has a spring-driven generator electrically connected with the LED.

5. The traffic cone assembly as claimed in claim 1, wherein the traffic cone assembly has a handle pivotally mounted on an outer surface of the base.

6. The traffic cone assembly as claimed in claim 2, wherein the traffic cone assembly has a handle pivotally mounted on an outer surface of the base.

7. The traffic cone assembly as claimed in claim 3, wherein the traffic cone assembly has a handle pivotally mounted on an outer surface of the base.

8. The traffic cone assembly as claimed in claim 4, wherein the traffic cone assembly has a handle pivotally mounted on an outer surface of the base.

9. The traffic cone assembly as claimed in claim 1, wherein
the base is a box and has
a bottom surface opposite to the top surface of the base;
a loop-shaped top rib mounted on the top surface of the base;
a loop-shaped bottom rib mounted on the bottom surface of the base and having a shape the same as that of the top rib, wherein an outer surface of the bottom rib of the traffic cone assembly is capable of abutting an inner surface of the top rib of another traffic cone assembly.

10. The traffic cone assembly as claimed in claim 2, wherein
the base is a box and has
a bottom surface opposite to the top surface of the base;
a loop-shaped top rib mounted on the top surface of the base;
a loop-shaped bottom rib mounted on the bottom surface of the base and having a shape the same as that of the top rib, wherein an outer surface of the bottom rib of the traffic cone assembly is capable of abutting an inner surface of the top rib of another traffic cone assembly.

11. The traffic cone assembly as claimed in claim 3, wherein
the base is a box and has
a bottom surface opposite to the top surface of the base;
a loop-shaped top rib mounted on the top surface of the base;
a loop-shaped bottom rib mounted on the bottom surface of the base and having a shape the same as that of the top rib, wherein an outer surface of the bottom rib of the traffic cone assembly is capable of abutting an inner surface of the top rib of another traffic cone assembly.

12. The traffic cone assembly as claimed in claim 4, wherein
the base is a box and has
a bottom surface opposite to the top surface of the base;
a loop-shaped top rib mounted on the top surface of the base;
a loop-shaped bottom rib mounted on the bottom surface of the base and having a shape the same as that of the top rib, wherein an outer surface of the bottom rib of the traffic cone assembly is capable of abutting an inner surface of the top rib of another traffic cone assembly.

13. The traffic cone assembly as claimed in claim 5, wherein
the base is a box and has
a bottom surface opposite to the top surface of the base;
a loop-shaped top rib mounted on the top surface of the base;
a loop-shaped bottom rib mounted on the bottom surface of the base and having a shape the same as that of the top rib, wherein an outer surface of the bottom rib of the traffic cone assembly is capable of abutting an inner surface of the top rib of another traffic cone assembly.

14. The traffic cone assembly as claimed in claim 6, wherein
the base is a box and has
a bottom surface opposite to the top surface of the base;
a loop-shaped top rib mounted on the top surface of the base;
a loop-shaped bottom rib mounted on the bottom surface of the base and having a shape the same as that of the top rib, wherein an outer surface of the bottom rib of the traffic cone assembly is capable of abutting an inner surface of the top rib of another traffic cone assembly.

15. The traffic cone assembly as claimed in claim 7, wherein
the base is a box and has
a bottom surface opposite to the top surface of the base;
a loop-shaped top rib mounted on the top surface of the base;
a loop-shaped bottom rib mounted on the bottom surface of the base and having a shape the same as that of the top rib, wherein an outer surface of the bottom rib of the traffic cone assembly is capable of abutting an inner surface of the top rib of another traffic cone assembly.

16. The traffic cone assembly as claimed in claim 8, wherein
the base is a box and has
a bottom surface opposite to the top surface of the base;
a loop-shaped top rib mounted on the top surface of the base;
a loop-shaped bottom rib mounted on the bottom surface of the base and having a shape the same as that of the top rib, wherein an outer surface of the bottom rib of the traffic cone assembly is capable of abutting an inner surface of the top rib of another traffic cone assembly.
